(19) United States
(12) Patent Application Publication
(10) Pub. No.: US 2025/0103412 A1
(43) Pub. Date: Mar. 27, 2025

(54) MULTI-FINE PROGRAM SCHEME FOR RELIABILITY RISK WORD LINES

(71) Applicant: Micron Technology, Inc., Boise, ID (US)

(72) Inventors: Yu-Chung LIEN, San Jose, CA (US); Ching-Huang LU, Fremont, CA (US); Zhenming ZHOU, San Jose, CA (US); Jun WAN, San Jose, CA (US)

(21) Appl. No.: 18/786,301

(22) Filed: Jul. 26, 2024

Related U.S. Application Data
(60) Provisional application No. 63/585,770, filed on Sep. 27, 2023.

(51) Int. Cl. G06F 11/00

(52) U.S. Cl. CPC G06F 11/008; G06F 2201/81

(57) ABSTRACT

In some implementations, a memory device may receive a program command instructing the memory device to program host data to a word line associated with a memory. The memory device may determine a program erase cycle (PEC) count associated with the word line. The memory device may determine, based on the PEC count, a selected program scheme to be used to program the host data to the word line, wherein the selected program scheme is one of a single-fine program scheme or a multi-fine program scheme. The memory device may execute the program command by performing the selected program scheme.

### CROSS-REFERENCE TO RELATED APPLICATION

This Patent application claims priority to U.S. Provisional Patent Application No. 63/585,770, filed on Sep. 27, 2023, entitled “MULTI-FINE PROGRAM SCHEME FOR RELIABILITY RISK WORD LINES,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to using a multi-fine program scheme for reliability risk word lines.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of selectively implementing a multi-fine program scheme for reliability risk word lines.

FIG. 2 is a diagram of example components included in a memory device.

FIG. 3 is another diagram of example components included in a memory device.

FIGS. 4A-4G are diagrams of examples associated with selective use of a multi-fine program scheme for reliability risk word lines.

FIG. 5 is a flowchart of an example method associated with selective use of a multi-fine program scheme for reliability risk word lines.

FIG. 6 is a flowchart of another example method associated with selective use of a multi-fine program scheme for reliability risk word lines.

FIG. 7 is a flowchart of another example method associated with selective use of a multi-fine program scheme for reliability risk word lines.

### DETAILED DESCRIPTION

Memory cells may undergo program erase cycles (PECs) in which host data is written to the memory cells, such as in response to receiving a program command from a host device, and in which the host data is later erased from the memory cells, such as in response to receiving an erase command from the host device. During some program schemes, a memory device may program a memory cell using two voltage pulses, including a first pulse (sometimes referred to as a coarse pulse and/or a coarse voltage), which may be used to set a voltage level of a memory cell in a general proximity of a final program voltage, and a second pulse (sometimes referred to as a fine pulse and/or a fine voltage), which may be used to set the voltage level of the memory cell to the final program voltage. Because in such program schemes only one fine pulse may be used to program the memory cell, the program scheme is sometimes referred to as a single-fine program scheme. Using a single-fine program scheme may result in data loss in certain portions of the memory (e.g., portions of the memory associated with a limited read write bandwidth (RWB)) because the single fine pulse may not accurately raise the memory cell voltage to a desired final program voltage.

In some examples, in order to improve a reliability of a memory, a double-fine program scheme may be implemented by the memory device, which may result in more precisely programmed cells and thus improved reliability, particularly for memory cells associated with a limited RWB. More particularly, during a double-fine program scheme, a memory device may use three program pulses to program a memory cell, including a coarse pulse, a first fine pulse, which may be used to set the voltage level of the memory cell near to the final program voltage, and a second fine pulse, which may be used to fine tune the voltage level of the memory cell to the final program voltage. Using a double-fine program scheme may result in improved data retention for memory cells associated with a limited RWB, as compared to a single-fine program scheme, because using two fine pulses may more accurately raise the memory cell voltage to a desired final program voltage.

Although the above-described double-fine program scheme may result in improved data retention as compared to a single-fine program scheme, the improvements come at a cost of higher power consumption and increased time needed to complete the double-fine program scheme. More particularly, the double-fine program scheme may take more time to complete than the single-fine program scheme because two fine pulses are used rather than the single fine pulse in the single-fine program scheme. Moreover, in light of the two fine pulses used, the double-fine program scheme may result in higher energy per bit (EPB) consumption than the single-fine program scheme. Accordingly, selection of a program scheme at a memory device may result in a tradeoff between relatively poor data retention, yet relatively low EPB consumption and relatively quick program procedures, on one hand when employing a single-fine program scheme, or else improved data retention, yet relatively high EPB consumption and relatively slow program operations, on the other hand when employing the double-fine program scheme.

Some implementations described herein enable a program scheme that results in improved data retention as compared to using the single-fine program scheme for programming all portions of a memory, while also resulting in reduced power consumption and quicker program procedures as compared to using the double-fine program scheme for programming all portions of the memory. More particularly, in some implementations, a memory device may selectively implement a single-fine program scheme for portions of a memory that are not associated with a reliability risk, while implementing a multi-fine program scheme (e.g., a program scheme that uses two or more fine pulses) for other portions of the memory that are associated with the reliability risk. For example, in response to receiving a program command from a host device, a memory device may determine whether a portion of a memory to be programmed is associated with a reliability risk. For example, certain portions of a memory may exhibit poorer data retention as a number of PECs associated with the memory increases and/or as an ambient temperature associated with the memory decreases. Accordingly, the memory device may determine a PEC count associated with the portion of the memory, a temperature associated with the portion of the memory, or a similar parameter. Based on the PEC count, the temperature, or the like, the memory device may determine if the portion of the memory is associated with a reliability risk, such as by using one or more lookup tables associated with PEC thresholds, temperature ranges, or the like. If the portion of the memory is not associated with a reliability risk, the memory device may execute the program command using a single-fine program scheme, thereby reducing power consumption and program time as compared to multi-fine program schemes. However, if the portion of the memory is associated with a reliability risk, the memory device may execute the program command using a multi-fine program scheme, thereby improving data retention as compared to single-fine program schemes.

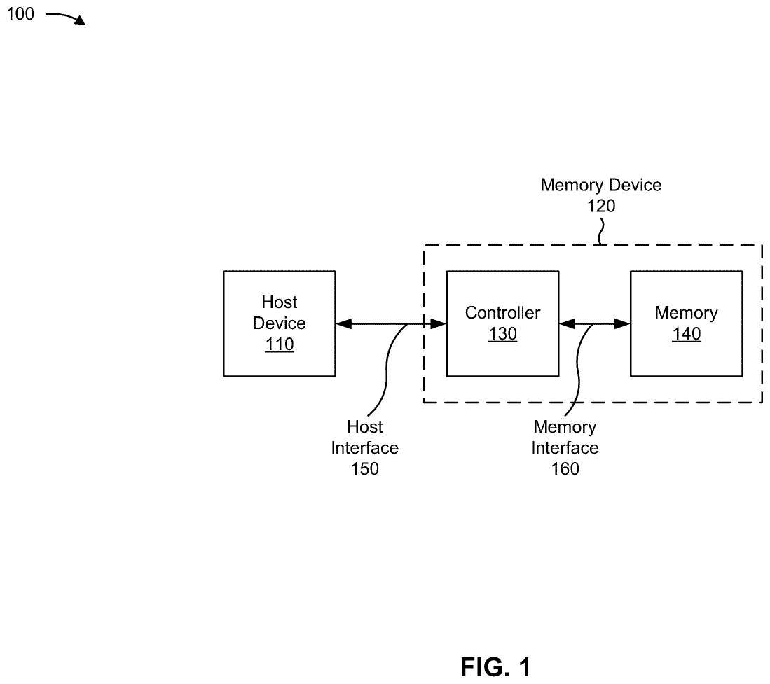

FIG. 1 is a diagram illustrating an example system 100 capable of selectively using a multi-fine program scheme for reliability risk word lines. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a graphics processing unit (GPU), a field-programmable gate array (FPGA), an application-specific integrated circuit (ASIC), and/or another type of processing component.

The memory device 120 may be any electronic device or apparatus configured to store data in memory. In some implementations, the memory device 120 may be an electronic device configured to store data persistently in non-volatile memory. For example, the memory device 120 may be a hard drive, a solid-state drive (SSD), a flash memory device (e.g., a NAND flash memory device or a NOR flash memory device), a universal serial bus (USB) thumb drive, a memory card (e.g., a secure digital (SD) card), a secondary storage device, a non-volatile memory express (NVMe) device, and/or an embedded multimedia card (eMMC) device. In this case, the memory 140 may include non-volatile memory configured to maintain stored data after the memory device 120 is powered off. For example, the memory 140 may include NAND memory or NOR memory. In some implementations, the memory 140 may include volatile memory that requires power to maintain stored data and that loses stored data after the memory device 120 is powered off, such as one or more latches and/or random-access memory (RAM), such as dynamic RAM (DRAM) and/or static RAM (SRAM). For example, the volatile memory may cache data read from or to be written to non-volatile memory, and/or may cache instructions to be executed by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be an SSD controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, and/or an embedded multimedia card (eMMC) interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be configured to receive, from a host device, a program command instructing the memory device to program host data to a portion of a memory; determine one of a PEC count associated with the portion of the memory or a temperature associated with the portion of the memory; determine, based on the one of the PEC count or the temperature, whether the portion of the memory is associated with a reliability risk; determine, based on whether the portion of the memory is associated with the reliability risk, a selected program scheme to be used to program the host data to the portion of the memory, wherein the selected program scheme is one of a single-fine program scheme or a multi-fine program scheme; and execute the program command by performing the selected program scheme.

In some implementations, one or more systems, devices, apparatuses, components, and/or controllers of FIG. 1 may be configured to receive a program command instructing the memory device to program host data to a word line associated with a memory; determine a PEC count associated with the word line; determine, based on the PEC count, a selected program scheme to be used to program the host data to the word line, wherein the selected program scheme is one of a single-fine program scheme or a multi-fine program scheme; and execute the program command by performing the selected program scheme.

In some implementations, one or more systems, devices, apparatuses, components, and/or controllers of FIG. 1 may be configured to receive a program command instructing the memory device to program host data to a word line associated with a memory; determine a temperature associated with the memory; determine, based on the temperature, a selected program scheme to be used to program the host data to the word line, wherein the selected program scheme is one of a single-fine program scheme or a multi-fine program scheme; and execute the program command by performing the selected program scheme.

As indicated above, FIG. 1 is provided as an example. Other examples may differ from what is described with regard to FIG. 1.

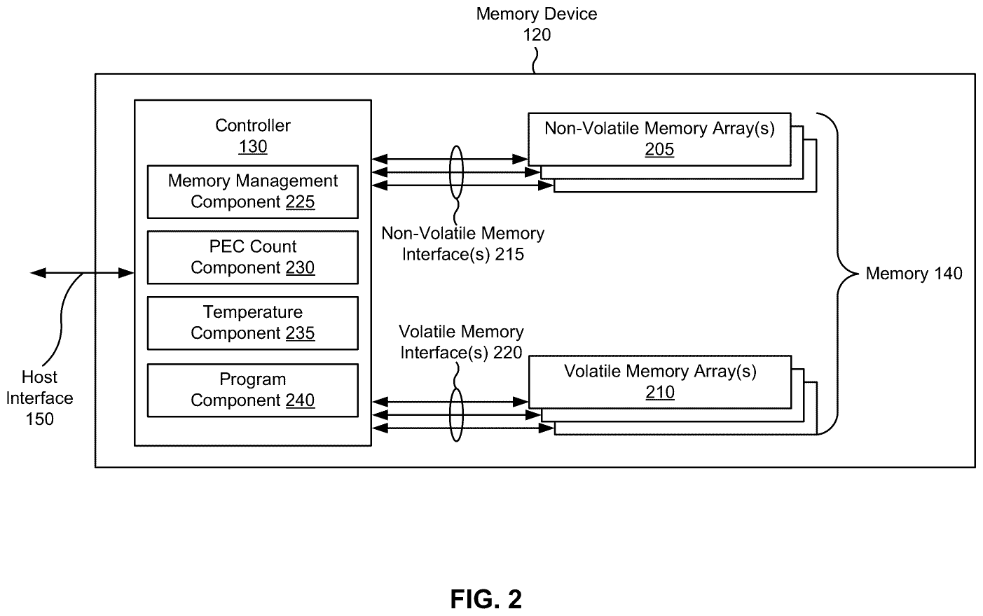

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, subblocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

As shown in FIG. 2, the controller 130 may include a memory management component 225, a PEC count component 230, a temperature component 235, and/or a program component 240. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear leveling, bad block management, block retirement, read disturb management, and/or other memory management operations. In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like).

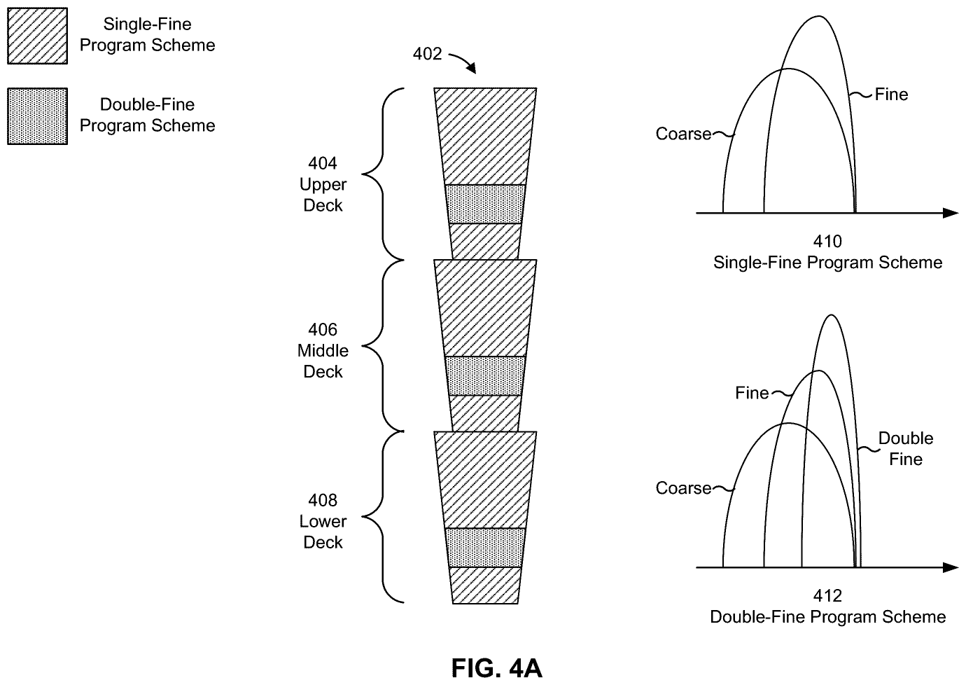

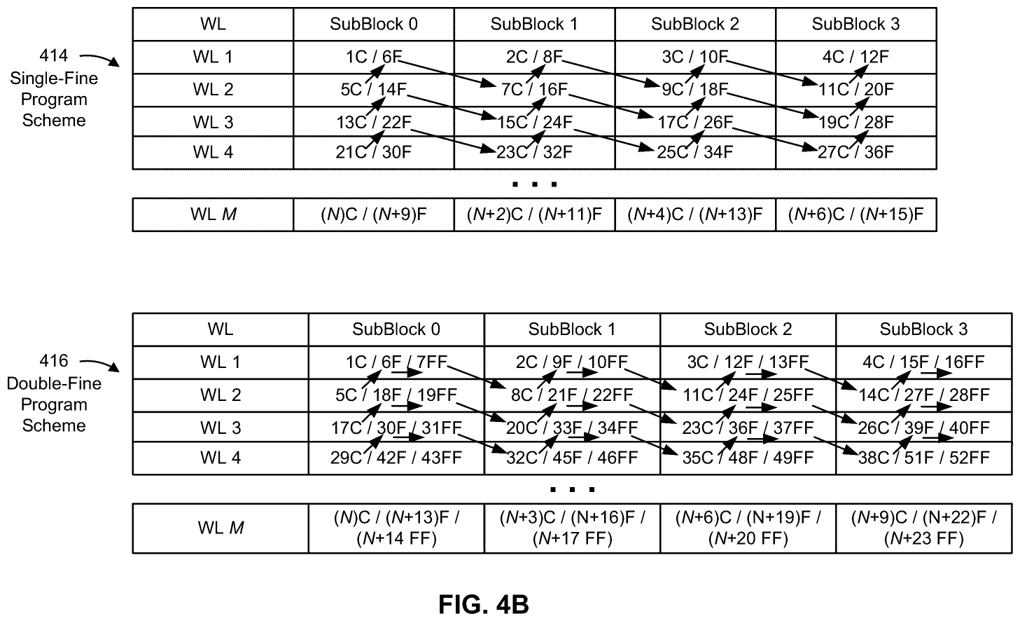

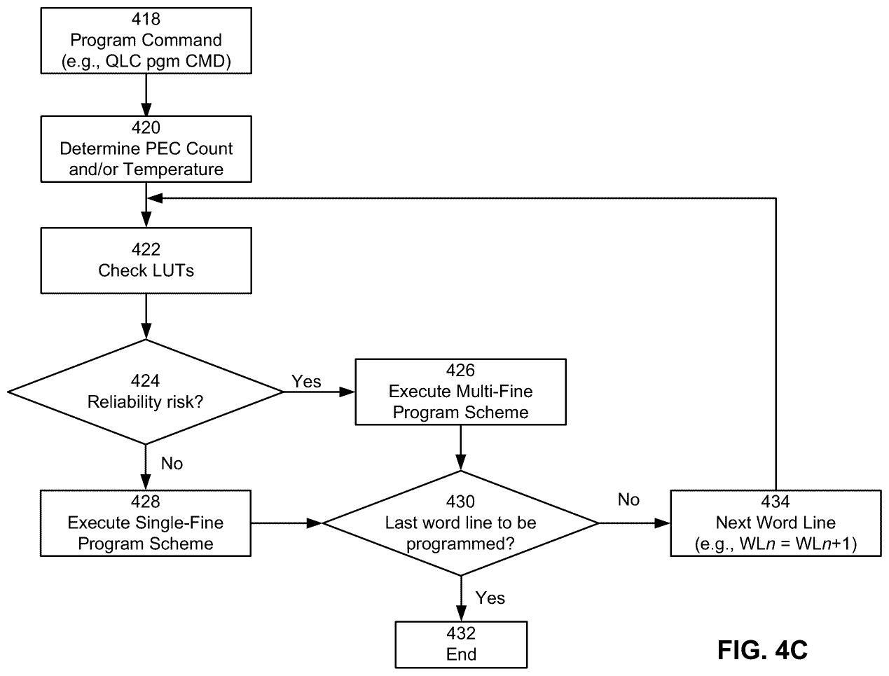

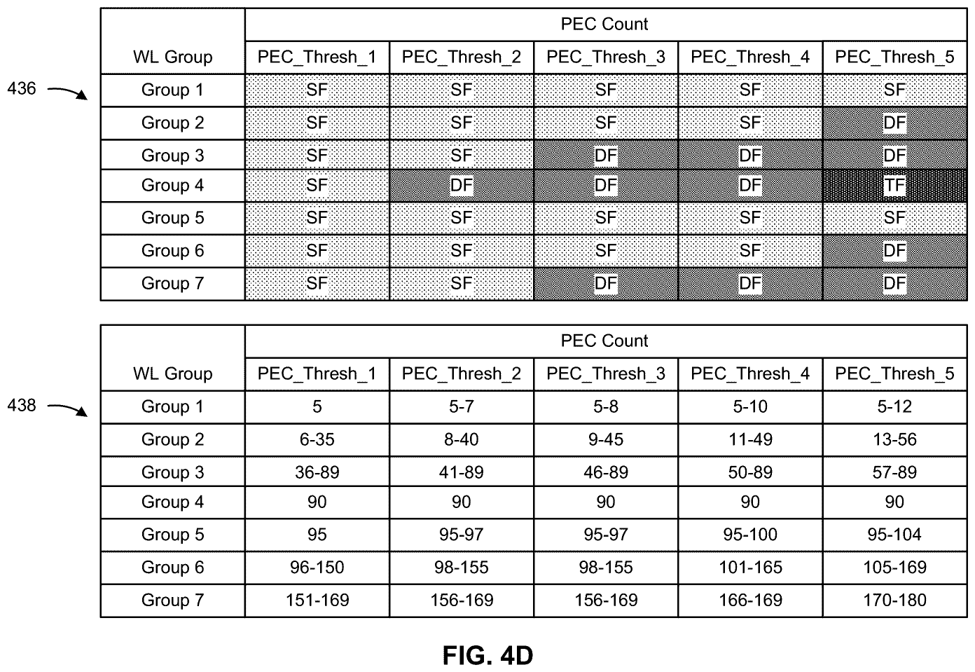

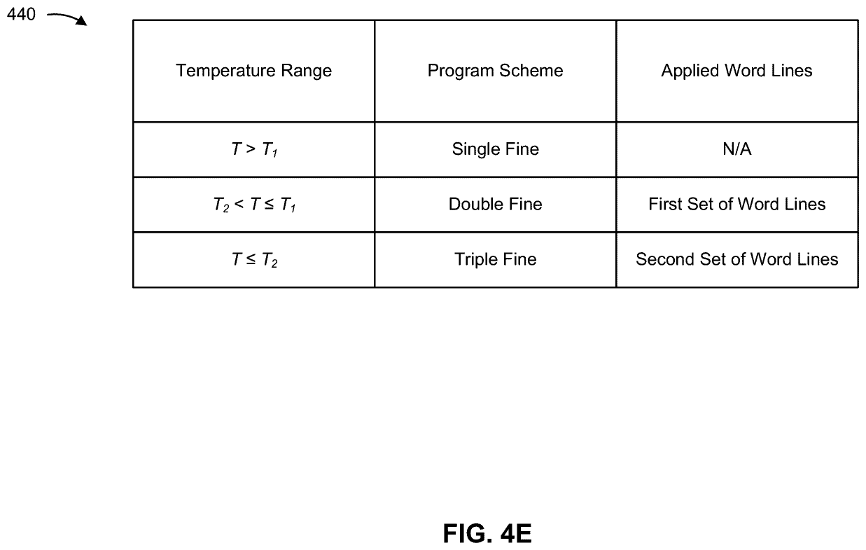

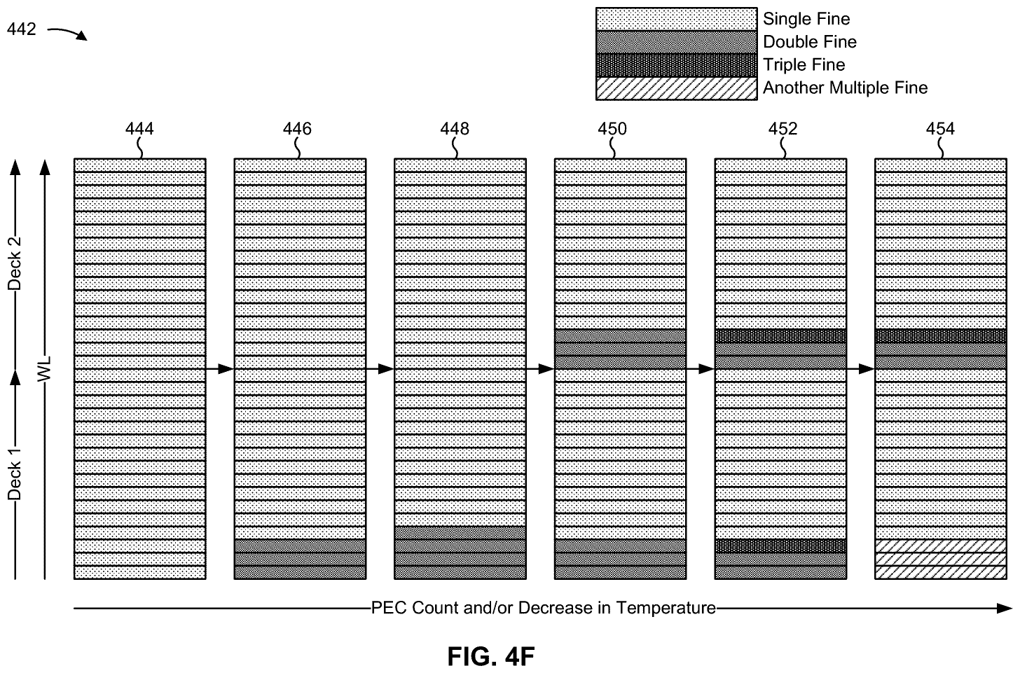

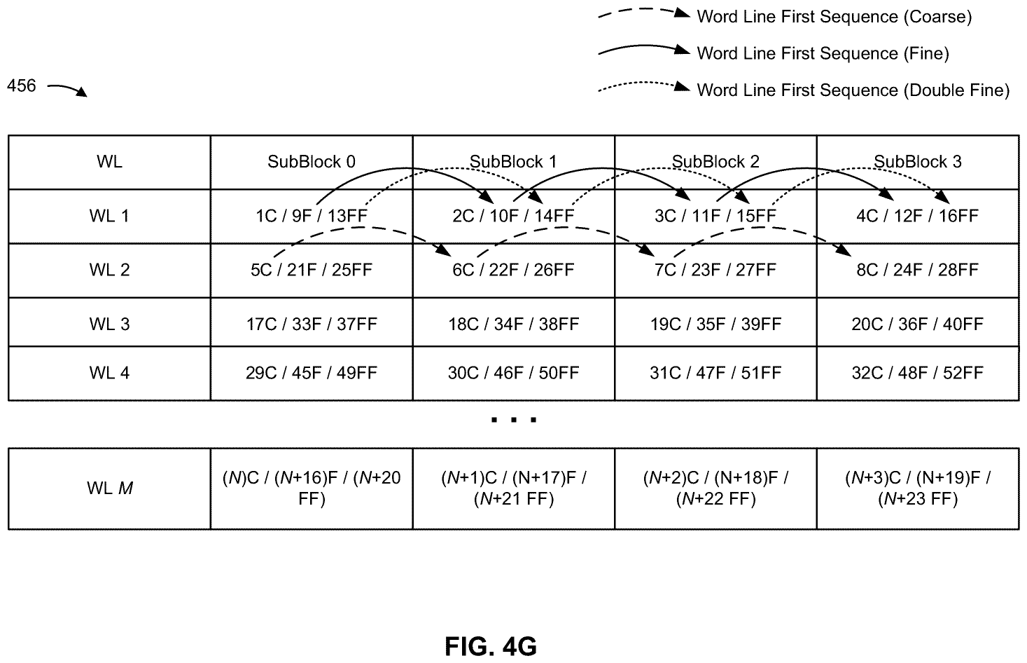

The PEC count component 230 may be configured to identify a PEC count associated with the memory 140, and/or to determine whether a portion of the memory 140 (e.g., a word line and/or a word line group) is associated with a reliability risk based on the PEC count. In some implementations, the PEC count component 230 may be associated with a lookup table, such as one of the lookup tables described below in connection with FIGS. 4A-4G. For example, the PEC count component 230 may be associated with a lookup table that associates certain reliability-risk word lines with corresponding PEC count thresholds, above which the corresponding word line becomes at risk for including write errors following a write procedure.

The temperature component 235 may be configured to monitor and/or identify a temperature associated with the memory 140, such as an ambient temperature in which the memory is operating, a temperature of one or more memory components, or the like. In some implementations, the temperature component 235 may include or may be associated with a thermometer to measure a temperature associated with the memory 140. The temperature component 235 may be configured to determine whether a portion of the memory 140 (e.g., a word line and/or a word line group) is associated with a reliability risk based on the temperature. In some implementations, the temperature component 235 may be associated with a lookup table, such as one of the lookup tables described below in connection with FIGS. 4A-4G. For example, the temperature component 235 may be associated with a lookup table that associates certain reliability-risk word lines with temperature ranges in which the corresponding word line becomes at risk for including write errors following a write procedure.

The program component 240 may be configured to program, or write, host data to the memory 140. In some implementations, the program component 240 may be configured to selectively implement one of multiple candidate program schemes in order to program or write host data to the memory 140, such as one of a single-fine program scheme or a multi-fine program scheme (e.g., a double-fine program scheme, a triple-fine program scheme, or another multi-fine program scheme). The program component 240 may be capable of applying a voltage to a memory cell, such as for a purpose of storing a threshold voltage corresponding to a binary value in the memory cell. For example, for quad-level cell (QLC) program commands, the program component 240 may be capable of programming each QLC to one of sixteen candidate voltage levels corresponding to one of binary 0000 through binary 1111.

One or more devices or components shown in FIG. 2 may be configured to perform operations described herein, such as one or more operations and/or methods described in connection with FIGS. 4A-4G. For example, the controller 130, the memory management component 225, the PEC count component 230, the temperature component 235, and/or the program component 240 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

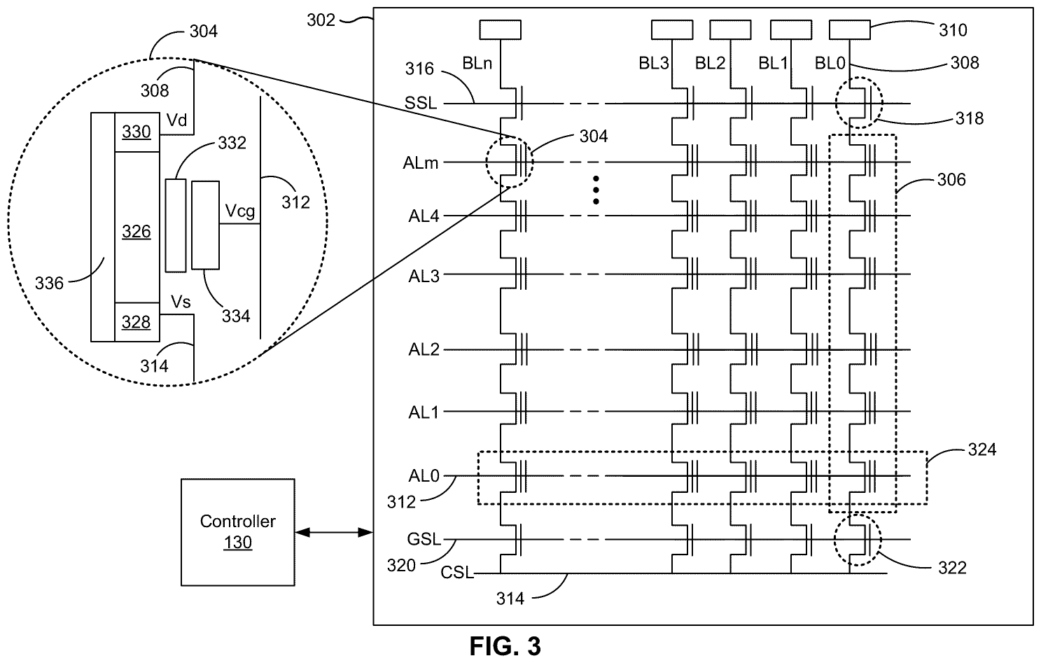

FIG. 3 is a diagram of example components included in a memory device 120. As described above in connection with FIG. 1, the memory device 120 may include a controller 130 and memory 140. As shown in FIG. 3, the memory 140 may include a memory array 302, which may correspond to a non-volatile memory array 205 described above in connection with FIG. 2.

In FIG. 3, the memory array 302 is a NAND memory array. However, in some implementations, the memory array 302 may be another type of memory array, such as a NOR memory array, a resistive RAM (RRAM) memory array, a magnetoresistive RAM (MRAM) memory array, a ferroelectric RAM (FeRAM) memory array, a spin-transfer torque RAM (STT-RAM) memory array, or the like. In some implementations, the memory array 302 is part of a three-dimensional stack of memory arrays, such as 3D NAND flash memory, 3D NOR flash memory, or the like.

The memory array 302 includes multiple memory cells 304. A memory cell 304 may store an analog value, such as an electrical voltage or an electrical charge, that represents a data state (e.g., a digital value). The analog value and corresponding data state depend on a quantity of electrons trapped or present within a region of the memory cell 304 (e.g., in a charge trap, such as a floating gate), as described below.

A NAND string 306 (sometimes called a string) may include multiple memory cells 304 connected in series. A NAND string 306 is coupled to a bit line 308 (sometimes called a digit line or a column line, and shown as BL0-BLn). Data can be read from or written to the memory cells 304 of a NAND string 306 via a corresponding bit line 308 using one or more input/output (I/O) components 310 (e.g., an I/O circuit, an I/O bus, a page buffer, and/or a sensing component, such as a sense amplifier). Memory cells 304 of different NAND strings 306 (e.g., one memory cell 304 per NAND string 306) may be coupled with one another via access lines 312 (sometimes called word lines or row lines, and shown as AL0-ALm) that select which row (or rows) of memory cells 304 is affected by a memory operation (e.g., a read operation or a write operation).

A NAND string 306 may be connected to a bit line 308 at one end and a common source line (CSL) 314 at the other end. A string select line (SSL) 316 may be used to control respective string select transistors 318. A string select transistor 318 selectively couples a NAND string 306 to a corresponding bit line 308. A ground select line (GSL) 320 may be used to control respective ground select transistors 322. A ground select transistor 322 selectively couples a NAND string 306 to the common source line 314.

A “page” of memory (or “a memory page”) may refer to a group of memory cells 304 connected to the same access line 312, as shown by reference number 324. In some implementations (e.g., for single-level cells), the memory cells 304 connected to an access line 312 may be associated with a single page of memory. In some implementations (e.g., for multi-level cells), the memory cells 304 connected to an access line 312 may be associated with multiple pages of memory, where each page represents one bit stored in each of the memory cells 304 (e.g., a lower page that represents a first bit stored in each memory cell 304 and an upper page that represents a second bit stored in each memory cell 304). In NAND memory, a page is the smallest physically addressable data unit for a write operation (sometimes called a program operation).

In some implementations, a memory cell 304 is a floating-gate transistor memory cell. In this case, the memory cell 304 may include a channel 326, a source region 328, a drain region 330, a floating gate 332, and a control gate 334. The source region 328, the drain region 330, and the channel 326 may be on a substrate 336 (e.g., a semiconductor substrate). The memory device 120 may store a data state in the memory cell 304 by charging the floating gate 332 to a particular voltage associated with the data state and/or to a voltage that is within a range of voltages associated with the data state. This results in a predefined amount of current flowing through the channel 326 (e.g., from the source region 328 to the drain region 330) when a specified read voltage is applied to the control gate 334 (e.g., by a corresponding access line 312 connected to the control gate 334). Although not shown, a tunnel oxide layer (or tunnel dielectric layer) may be interposed between the floating gate 332 and the channel 326, and a gate oxide layer (e.g., a gate dielectric layer) may be interposed between the floating gate 332 and the control gate 334. As shown, a drain voltage Vd may be supplied from a bit line 308, a control gate voltage Veg may be supplied from an access line 312, and a source voltage Vs may be supplied via the common source line 314 (which, in some implementations, is a ground voltage).

To write or program the memory cell 304, Fowler-Nordheim tunneling may be used. For example, a strong positive voltage potential may be created between the control gate 334 and the channel 326 (e.g., by applying a large positive voltage to the control gate 334 via a corresponding access line 312) while current is flowing through the channel 326 (e.g., from the common source line 314 to the bit line 308, or vice versa). The strong positive voltage at the control gate 334 causes electrons within the channel 326 to tunnel through the tunnel oxide layer and be trapped in the floating gate 332. These negatively charged electrons then act as an electron barrier between the control gate 334 and the channel 326 that increases the threshold voltage of the memory cell 304. The threshold voltage is a voltage required at the control gate 334 to cause current (e.g., a threshold amount of current) to flow through the channel 326. Fowler-Nordheim tunneling is an example technique for storing a charge in the floating gate, and other techniques, such as channel hot electron injection, may be used. In some implementations, multiple voltage passes, or pulses, may be used to write or program the memory cell 304. For example, a coarse voltage may be applied to the memory cell 304 during a first pulse, and one or more fine pulses may be applied to the memory cell 304 during subsequent pulses, which is described in more detail below in connection with FIG. 4A.

To read the memory cell 304, a read voltage may be applied to the control gate 334 (e.g., via a corresponding access line 312), and an I/O component 310 (e.g., a sense amplifier) may determine the data state of the memory cell 304 based on whether current passes through the memory cell 304 (e.g., the channel 326) due to the applied voltage. A pass voltage may be applied to all memory cells 304 (other than the memory cell 304 being read) in the same NAND string 306 as the memory cell 304 being read. For example, the pass voltage may be applied on each access line 312 other than the access line 312 of the memory cell 304 being read (e.g., where the read voltage is applied). The pass voltage is higher than the highest read voltage associated with any memory cell data states so that all of the other memory cells 304 in the NAND string 306 conduct, and the I/O component 310 can detect a data state of the memory cell 304 being read by sensing current (or lack thereof) on a corresponding bit line 308. For example, in a single-level memory cell that stores one of two data states, the data state is a “1” if current is detected, and the data state is a “0” if current is not detected. In a multi-level memory cell that stores one of three or more data states, multiple read voltages are applied, over time, to the control gate 334 to distinguish between the three or more data states and determine a data state of the memory cell 304.

To erase the memory cell 304, a strong negative voltage potential may be created between the control gate 334 and the channel 326 (e.g., by applying a large negative voltage to the control gate 334 via a corresponding access line 312). The strong negative voltage at the control gate 334 causes trapped electrons in the floating gate 332 to tunnel back across the oxide layer from the floating gate 332 to the channel 326 and to flow between the common source line 314 and the bit line 308. This removes the electron barrier between the control gate 334 and the channel 326 and decreases the threshold voltage of the memory cell 304 (e.g., to an empty or erased state, which may represent a “1”). In NAND memory, a block is the smallest unit of memory that can be erased. A block of NAND memory includes multiple pages. Thus, an individual page of a block cannot be erased without erasing every other page of the block. In some implementations, a block may be divided into multiple subblocks. A subblock is a portion of a block and may include a subset of pages of the block and/or a subset of memory cells of the block.

As indicated above, FIG. 3 is provided as an example. Other examples may differ from what is described with regard to FIG. 3.

FIGS. 4A-4G are diagrams of examples associated with selective implementation of multi-fine program schemes for reliability risk word lines. The operations described in connection with FIGS. 4A-4G may be performed by the memory device 120 and/or one or more components of the memory device 120, such as the controller 130 and/or one or more components of the controller 130.

As shown in FIG. 4A, and as indicated by reference number 402, a memory (e.g., memory 140) may be associated with a three-dimensional architecture, sometimes referred to as a multi-deck memory architecture. The example multi-deck memory architecture shown in FIG. 4A is a three-deck memory architecture including an upper deck 404, a middle deck 406, and a lower deck 408, but, in some other implementations, a multi-deck memory architecture may include a different number of decks (e.g., two decks or more than three decks).

In some implementations, due to the geometry of the multi-deck memory architecture (e.g., due to a geometry of a central pillar of the multi-deck memory) and/or due to other factors (e.g., due to varying word-line resistances in the multi-deck memory), certain portions of the multi-deck memory architecture may exhibit poor data retention capabilities and/or may otherwise be associated with a reliability risk. For example, word lines located near a top of a deck and/or a bottom of a deck may have poor reliability as compared to word lines located elsewhere in the deck. Accordingly, in some implementations, a multi-fine program scheme (e.g., a double-fine program scheme, a triple-fine program scheme, or another multi-fine program scheme) may be used for the portions of each deck that pose a reliability risk. For example, as indicated using stippling in FIG. 4A, most word lines of each deck may not be associated with a reliability risk, and thus a single-fine program scheme may be used when writing host data to those word lines. As indicated by reference number 410, the single-fine program scheme may use two voltage passes and/or pulses to set a voltage level of each memory cell. During a first pass and/or pulse (e.g., a coarse pulse), a voltage level of a memory cell may be set to a general proximity of a final program voltage. During a second pass and/or pulse (e.g., a fine pulse), a voltage applied to the memory cell may be more concentrated and/or fine-tuned in order to set the voltage level of the memory cell to the final program voltage.

Moreover, as indicated using cross-hatching in FIG. 4A, certain word lines of each deck may be associated with a reliability risk, and thus a multi-fine program (e.g., a double-fine program scheme, a triple-fine program scheme, or the like) may be used when writing host data to those word lines. As indicated by reference number 412, a double-fine program scheme may use three voltage passes and/or pulses to set a voltage level of each memory cell. During a first pass and/or pulse (e.g., a coarse pulse), a voltage level of a memory cell may be set to a general proximity of a final program voltage. During a second pass and/or pulse (e.g., a fine pulse), a voltage applied to the memory cell may be more concentrated and/or fine-tuned in order to set the voltage level of the memory cell very near to the final program voltage. And during a third pass and/or pulse (sometimes referred to herein as a double fine pulse), a voltage applied to the memory cell may be even more concentrated and/or fine-tuned in order to set the voltage level of the memory cell to the final program voltage. For triple-fine program schemes, quad-fine program schemes, or other multi-fine program schemes, additional fine pulses may be implemented (e.g., a triple fine pulse for triple-fine program schemes, a triple fine pulse and a quad-fine pulse for quad-fine program schemes, and so forth).

FIG. 4B shows example tables indicating programming sequences associated with a single-fine program scheme and a double-fine program scheme. More particularly, reference number 414 shows a table indicating an example programming sequence associated with a single-fine program scheme, such as the single-fine program scheme described above in connection with reference number 410, and reference number 416 shows a table indicating an example programming sequence associated with a double-fine program scheme, such as the double-fine program scheme described above in connection with reference number 412. In the tables indicated by reference numbers 414 and 416, an order of a program operation is shown using a numeral (e.g., “1” for the first program operation to be performed by a memory device, “2” for the second program operation to be performed by the memory device, and so forth), and a type of programming pulse to be performed at each operation is shown using letters (e.g., “C” for a coarse pulse, “F” for a fine pulse, and “FF” for a double fine pulse).

As shown in the single-fine program scheme table indicated by reference number 414, for a first word line to be programmed (indexed as “WL 1” in FIG. 4B), the memory device may perform a coarse pulse on each subblock to be programmed (indexed as subblock 0 through subblock 3 in FIG. 4B). More particularly, the memory device may first perform a coarse pulse on subblock 0 (shown as “1C”), may next perform a coarse pulse on subblock 1 (shown as “2C”), and so forth through subblock 3 (shown as “4C”). The memory device may then perform a coarse pulse on a first subblock (e.g., subblock 0) of the next word line to be programmed (e.g., WL 2), shown as “5C.” Rather than performing a coarse pulse on each subblock of the second word line, however, the memory device may next perform a fine pulse on a first subblock of the first word line (e.g., WL 1), shown as “6F.” In this regard, for the second and subsequent word lines to be programmed, the memory device may perform multiple programming pulses (e.g., a coarse pulse on an M-th word line of the subblock, and a fine pulse on an (M−1)-th word line of the subblock), prior to performing operations on a next subblock of the M-th word line. In some implementations, performing program operations in this sequence may be referred to herein as a subblock-first program sequence.

After performing the fine pulse on the first word line (e.g., WL 1) associated with the first subblock (e.g., subblock 0), the memory device may proceed with performing a coarse pulse on the second word line (e.g., WL 2) in the second subblock (e.g., subblock 1) as indicated by “7C,” performing a fine pulse on the first word line (e.g., WL 1) in the second subblock (e.g., subblock 1) as indicated by “8F,” and so forth as indicated using arrows in the single-fine program scheme table indicated by reference number 414. More generally, for the second and subsequent word lines, for a given word line M, the first subblock (e.g., subblock 0) may be associated with an N-th coarse pulse and an (N+9)-th fine pulse, the second subblock (e.g., subblock 1) may be associated with an (N+2)-th coarse pulse and an (N+11)-th fine pulse, the third subblock (e.g., subblock 2) may be associated with an (N+4)-th coarse pulse and an (N+13)-th fine pulse, and the fourth subblock (e.g., subblock 3) may be associated with an (N+6)-th coarse pulse and an (N+15)-th fine pulse, and so forth.

In some implementations, the double-fine program scheme may be associated with a similar subblock-first program scheme, but one that uses two fine pulses instead of one fine pulse. More particularly, as shown in the double-fine program scheme table indicated by reference number 416, for a first word line to be programmed (e.g., WL 1), the memory device may perform a coarse pulse on each subblock to be programmed, such as a coarse pulse on subblock 0 (shown as “1C”), a coarse pulse on subblock 1 (shown as “2C”), and so forth through subblock 3 (shown as “4C”). The memory device may then perform a coarse pulse on a first subblock (e.g., subblock 0) of the next word line to be programmed (e.g., WL 2), shown as “5C.” The memory device may then perform a fine pulse on a first subblock of the first word line (e.g., WL 1), shown as “6F,” as well as a double fine pulse on the first subblock of the first word line, shown as “7FF.” In this regard, for the second and subsequent word lines to be programmed, the memory device may perform multiple programming pulses (e.g., a coarse pulse on an M-th word line of the subblock, a fine pulse on an (M−1)-th word line of the subblock, and a double fine pulse on the (M−1)-th word line of the subblock), prior to moving to a next subblock (e.g., the memory device may use a subblock-first program scheme).

After performing the fine pulse and the double fine pulse on the first word line (e.g., WL 1) associated with the first subblock (e.g., subblock 0), the memory device may proceed with performing a coarse pulse on the second word line (e.g., WL 2) in the second subblock (e.g., subblock 1) as indicated by “8C,” performing a fine pulse and a double fine pulse on the first word line (e.g., WL 1) in the second subblock (e.g., subblock 1) as indicated by “9F” and “10FF,” respectively, and so forth as indicated using arrows in the double-fine program scheme table indicated by reference number 416. More generally, for the second and subsequent word lines, for a given word line M, the first subblock (e.g., subblock 0) may be associated with an N-th coarse pulse, an (N+13)-th fine pulse, and an (N+14)-th double fine pulse; the second subblock (e.g., subblock 1) may be associated with an (N+3)-th coarse pulse, an (N+16)-th fine pulse, and an (N+17)-th double fine pulse; the third subblock (e.g., subblock 2) may be associated with an (N+6)-th coarse pulse, an (N+19)-th fine pulse, and an (N+20)-th double fine pulse; and the fourth subblock (e.g., subblock 3) may be associated with an (N+9)-th coarse pulse, an (N+22)-th fine pulse, and an (N+23)-th double fine pulse.

Using a single-fine program scheme, such as the single-fine program scheme shown in connection with reference number 410 and/or described in connection with the program sequence table indicated by reference number 414, to program a majority of the word lines of the memory may result in reduced power consumption as compared to implementations in which a multi-fine program scheme is used for all word lines in a memory deck, because fewer fine voltage passes are needed to set a final program voltage of each memory cell. Moreover, selectively implementing a multi-fine program scheme, such as the double-fine program scheme shown in connection with reference number 412 and/or described in connection with the program sequence table indicated by reference number 416, to program reliability-risk word lines of the memory may result in increased reliability as compared to implementations in which a single-fine program scheme is used for all word lines in a memory deck, because the additional fine voltage passes at the reliability-risk word lines may improve an RWB associated with the reliability-risk word lines and/or may improve data retention of the reliability-risk word lines. For example, using a multi-fine program scheme for reliability-risk word lines may result in more accurate and/or tightly concentrated program voltages, thereby improving an RWB associated with the memory.

In some implementations, certain conditions may affect a reliability of a word line or group of word lines, such that a word line or group of word lines that would not pose a reliability risk under certain circumstances may pose a reliability risk under other circumstances. For example, an integrity of a dielectric associated with a memory may degrade as a PEC count associated with the memory increases. Accordingly, as a PEC count of a memory increases, a quantity of word lines that may pose a reliability risk may also increase. Put another way, certain word lines that may not pose a reliability risk at relatively low PEC counts may nonetheless pose a reliability risk at relatively high PEC counts. Additionally, or alternatively, temperature may adversely affect a reliability of a memory. For example, a reliability of a memory may be proportional to an ambient temperature, such that as temperatures associated with the memory decrease, certain word lines may pose a reliability risk that may not otherwise pose a reliability risk at relatively high temperatures. Accordingly, in some implementations, a memory device may determine whether a word line being programmed is associated with a reliability risk based on a PEC count associated with the word line and/or a temperature associated with the word line.

More particularly, FIG. 4C shows example operations that may be performed by a memory device (e.g., memory device 120) to selectively implement a multi-fine program scheme for reliability-risk word lines. As shown in FIG. 4C, and as indicated by reference number 418, the memory device may receive, from a host device (e.g., host device 110), a program command instructing the memory device to program host data to a portion of a memory (e.g., memory 140). For example, the program command may instruct the memory device to program the host data to a group of word lines (e.g., access lines 312) associated with the memory. In some implementations, the program command may be associated with a QLC program command (e.g., a program command that instructs the memory device to write the host data to QLC memory). In such implementations, certain word lines associated with the QLC program command may pose a reliability risk as described above, such as due to a limited RWB of QLC memory as compared to other types of memory (e.g., multi-level (MLC) memory, triple-level cell (TLC) memory, or the like). However, in some other implementations, the program command and/or the memory may be associated with a different type of memory, such as a TLC memory, a penta-level cell (PLC) memory, or a similar type of memory.

As indicated by reference number 420, the memory device may determine a PEC count associated with the portion of the memory (e.g., a word line to be programmed) or a temperature associated with the portion of the memory. That is, in some implementations, a reliability of certain word lines may be dependent on a quantity of PECs associated with the memory, an operating temperature of the memory, or the like, as described above. Accordingly, the memory device may determine a PEC count associated with the portion of the memory (e.g., a word line to be programmed) or a temperature associated with the portion of the memory, such as for a purpose of making a determination as to whether the portion of the memory poses a reliability risk given the current PEC count, temperature, or the like.

In some implementations, the memory device may make a determination as to whether the portion of the memory poses a reliability risk given the current PEC count, the current temperature, or the like, based on referencing a data structure, such as a lookup table or a similar structure. In such implementations, and as indicated by reference number 422, the memory device may check one or more lookup tables to determine if a word line to be programmed is indicated as being associated with a multi-fine program scheme for the corresponding PEC count, temperature, or the like. For example, a lookup table may indicate a program scheme to be used for each of multiple groups of word lines for a given PEC threshold, may indicate certain word lines for which a multi-fine program scheme is to be used for a given temperature, or the like. Aspects of various lookup tables that a memory device may reference in connection with operations described in connection with reference number 422 are described in more detail below in connection with FIGS. 4D-4E.

As indicated by reference number 424, the memory device may determine, based on the PEC count and/or the temperature, whether the portion of the memory is associated with a reliability risk, and/or based on whether the portion of the memory is associated with the reliability risk, a selected program scheme to be used to program the host data to the portion of the memory. For example, the memory device may determine if a word line to be programmed to is a word line that is specified (e.g., by a lookup table or similar data structure) as being associated with a multi-fine program scheme, such as a double-fine program scheme, a triple-fine program scheme, or the like. If the memory device determines that a word line to be programmed to is a reliability risk (e.g., the word line is one that is specified as being associated with a multi-fine program scheme in a lookup table or the like), the memory device may select a multi-fine program scheme to execute the program command (e.g., a double-fine program scheme, a triple-fine program scheme, or a similar multi-fine program scheme, which may be indicated by a lookup table or similar data structure). On the other hand, if the memory device determines that a word line to be programmed to is not a reliability risk (e.g., the word line is not one that is specified as being associated with a multi-fine program scheme in a lookup table or the like), the memory device may select the single-fine program scheme to execute the program command.

As indicated by reference numbers 426 and 428, the memory device may execute the program command by performing the selected program scheme. More particularly, as indicated by reference number 426, when the word line to be programmed to is a reliability risk (e.g., the word line is one that is specified as being associated with a multi-fine program scheme in a lookup table or the like), the memory device may execute the multi-fine program scheme, such as a double-fine program scheme, a triple-fine program scheme, or another multi-fine program scheme. When the word line to be programmed to is not a reliability risk (e.g., the word line is not one that is specified as being associated with a multi-fine program scheme in a lookup table or the like), the memory device may execute the single-fine program scheme.

As indicated by reference number 430, the memory device may determine whether additional word lines are to be programmed in connection with the program command. As shown by reference number 432, when no additional word lines are to be programmed (e.g., when a final word line has been programmed by the memory device), the operations may end. However, as indicated by reference number 434, when more word lines are to be programmed (e.g., when another word line associated with the program command, sometimes referred to as WLn+1, is to be programmed after the current word line being programmed, sometimes referred to as WLn), the memory device may perform one or more of the operations for the next word line, including checking a lookup table to determine if the word line (e.g., WLn+1) is specified as being associated with a multi-fine program scheme given the PEC count and/or temperature, and executing one of the single-fine program scheme or the multi-fine program scheme, accordingly.

FIG. 4D shows example lookup tables that may be used by a memory device to selectively implement one of a single-fine program scheme or a multi-fine program scheme, such as in implementations in which the memory device selectively implements one of a single-fine program scheme or a multi-fine program scheme based on a PEC count associated with the memory. For example, as indicated by reference number 436, in some implementations a lookup table may indicate multiple PEC count thresholds (shown in FIG. 4D as a first PEC count threshold, PEC_Thresh_1, through a fifth PEC count threshold, PEC_Thresh_5) and, for each PEC count threshold, of the multiple PEC count thresholds, a corresponding program scheme for each of multiple word line groups (shown in FIG. 4D as a first word line group, Group 1, through a seventh word line group, Group 7).

More particularly, at each PEC count threshold, the lookup table may indicate whether a single-fine program scheme (shown in FIG. 4D as “SF”), a double-fine program scheme (shown in FIG. 4D as “DF”), or a triple-fine program scheme (shown in FIG. 4D as “TF”) should be used to program data to word lines in the various word line groups. Thus, when determining which program scheme is to be used to execute a program command at a given word line, the memory device may determine a PEC count associated with the memory (as described above in connection with reference number 420) and/or may identify a program scheme associated with a word line group that includes the word line for a corresponding PEC count threshold (e.g., a highest threshold, of the multiple PEC count thresholds, that is satisfied by the PEC count). For example, if a memory device determines that a PEC count associated with the memory satisfies the fourth PEC count threshold (PEC_Thresh_4) but not the fifth PEC count threshold (PEC_Thresh_5), the memory device may determine a program scheme using the column under the heading “PEC_Thresh_4.” In that regard, if a word line being programmed (e.g., WLn) is in Group 2, the memory device may thus use a single-fine program scheme (as indicated by “SF” in the cell corresponding to PEC_Thresh_4 and Group 2). Similarly, if a word line being programmed is in Group 4, the memory device may thus use a double-fine program scheme (as indicated by “DF” in the cell corresponding to PEC_Thresh_4 and word Group 2).

As indicated in the lookup table shown by reference number 436, for higher PEC count thresholds, more word line groups may be subject to a multi-fine program scheme as compared to lower PEC count thresholds, which may be reflective of certain word lines posing an increased reliability risk as a PEC count increases (e.g., due to dielectric degradation, or the like). More particularly, at the first PEC count threshold (e.g., PEC_Thresh_1), each word line group may be associated with a single-fine program scheme. However, at the fifth PEC count threshold (e.g., PEC_Thresh_5), only two word line groups are associated with the single-fine program scheme (e.g., Group 1 and Group 5). The remaining word line groups may be associated with a multi-fine program scheme (e.g., either a double-fine program scheme or a triple-fine program scheme). More particularly, Groups 2, 3, 6, and 7 may be associated with a double-fine program scheme, and Group 4 may be associated with a triple-fine program scheme. In that regard, a given word line may be associated with various program schemes at different PEC count thresholds. For example, a word line may be associated with a single-fine program scheme when a corresponding PEC count satisfies one PEC count threshold (e.g., PEC_Thresh_1_), a double-fine program scheme when the corresponding PEC count satisfies another PEC threshold (e.g., PEC_Thresh_2), and a triple-fine program scheme when the corresponding PEC count satisfies yet another PEC threshold (e.g., PEC_Thresh_5).

In some implementations, a set of one or more word lines included in each group of word lines (e.g., each of Group 1 through Group 7) may be the same at each PEC count threshold, while, in some other implementations, a set of one or more word lines included in each group of word lines may differ at different PEC count thresholds. Put another way, a given word line group may be associated with a first set of one or more word lines at a first PEC count threshold and may be associated with a second set of one or more word lines, that is different from the first set of one or more word lines, at a second PEC count threshold. For example, the lookup table shown in connection with reference number 438 shows a lookup table that associates the various PEC count thresholds with sets of word lines in each word line group. For at least some of the word line groups, a set of word lines associated with the word line group may differ at different PEC count thresholds. For example, word line group 3 may include word lines indexed as 36-89 at the first PEC count threshold (e.g., PEC_Thresh_1), word lines indexed as 41-89 at the second PEC count threshold (e.g., PEC_Thresh_2), word lines indexed as 46-89 at the third PEC count threshold (e.g., PEC_Thresh_3), word lines indexed as 50-89 at the fourth PEC count threshold (e.g., PEC_Thresh_4), and word lines indexed as 57-89 at the fifth PEC count threshold (e.g., PEC_Thresh_5). Amending a set of word lines within a specific word line group may differ as a function of PEC count, which may enable accommodation of more word lines that are subject to multi-fine program schemes at higher PEC counts.

FIG. 4E shows another example lookup table that may be used by a memory device to selectively implement one of a single-fine program scheme or a multi-fine program scheme, such as in implementations in which the memory device selectively implements one of a single-fine program scheme or a multi-fine program scheme based on a temperature associated with the memory (indicated in FIG. 4D as “T”). For example, as indicated by reference number 440, in some implementations a lookup table may indicate multiple temperature ranges, and, for each temperature range, a corresponding program scheme and a corresponding set of word lines associated with the corresponding program scheme. More particularly, the lookup table indicated by reference number 440 includes three temperature ranges, including a first range that corresponds to a temperature associated with the memory (e.g., T) being greater than a first temperature (T1), a second range that corresponds to a temperature associated with the memory being greater than a second temperature (T2) but less than or equal to the first temperature, and a third range that corresponds to a temperature associated with the memory being less than or equal to the second temperature. At the first temperature range (e.g., T>T1), the lookup table may indicate that a single-fine program scheme is to be used for every word line., which may be reflective that all word lines pose little reliability risk at high temperatures. However, at the second temperature range (e.g., T2<T≤T1), the lookup table may indicate that a double-fine program scheme is to be used for certain word lines that pose a reliability risk at that temperature range (indicated in FIG. 4E as a first set of word lines), with the remaining word lines (e.g., the word lines not included in the first set of word lines) being associated with a single-fine program scheme. And at the third temperature range (e.g., T≤T2), the lookup table may indicate that a triple-fine program scheme is to be used for certain word lines that pose a reliability risk at that temperature range (indicated in FIG. 4E as a second set of word lines), with the remaining word lines (e.g., the word lines not included in the second set of word lines) being associated with either a single-fine program scheme or a double-fine word line scheme. In some implementations, the first set of word lines may be the same as the second set of word lines, while, in some other implementations, the first set of word lines may differ from the second set of word lines (e.g., the second set of word lines may include more word lines than the first set of word lines).

More broadly, using one of the lookup tables described above in connection with FIG. 4D and FIG. 4E and/or a similar lookup table or data structure, the memory device may be configured to selectively implement one of multiple candidate program schemes based on a reliability risk category associated with a word line being programmed (e.g., one of a low reliability risk category corresponding to using a single-fine program scheme, a medium reliability risk category corresponding to using a double-fine program scheme, or a high reliability risk category corresponding to using a triple-fine program scheme). Put another way, when determining whether a portion of a memory to be programmed to is associated with a reliability risk and/or when determining a selected program scheme to be used to program host data to the portion of the memory (e.g., as described above in connection with reference number 424), the memory device may be configured to select the single-fine program scheme when the portion of the memory is associated with a first reliability risk category (e.g., a low reliability risk category), select a first type of multi-fine program scheme (e.g., a double-fine program scheme) when the portion of the memory is associated with a second reliability risk category (e.g., a medium reliability risk category), and/or select a second type of multi-fine program scheme (e.g., a triple-fine program scheme) when the portion of the memory is associated with a third reliability risk category (e.g., a high reliability risk category).

FIG. 4F schematically depicts how program schemes may differ for certain word lines and/or word line zones based on a PEC count associated with a memory and/or a temperature associated with the memory. More particularly, reference number 442 shows a multi-deck memory (e.g., a two-deck memory, including two decks shown in FIG. 4F as “Deck 1” and “Deck 2”), with each deck including multiple word lines (shown in FIG. 4F as “WL”). As indicated using light stippling, for relatively low PEC counts and/or relatively high temperatures, most of the word lines associated with the memory may pose little reliability risk, and thus most or all of the word lines may be associated with a single-fine program scheme.

However, as a PEC count increases and/or temperate decreases, one or more multi-fine program schemes (indicated using increasingly darker stippling corresponding to a number of additional fine pulses used) may be used for certain reliability-risk word lines (e.g., word lines that exhibit a poor RWB at high PEC counts and/or low temperatures). In some implementations, as a PEC count increases and/or temperate decreases, one or more multi-fine program schemes may be used for zones that include multiple word lines, with at least one of the word lines in a zone being associated with a reliability-risk word line. For example, as indicated by reference number 444, at a first PEC count and/or a first temperature, all word lines may be associated with a single-fine program scheme. However, as indicated by reference number 446, at a second PEC count and/or a second temperature, one zone of word lines (e.g., a zone that includes three word lines) may be associated with a double-fine word line scheme, and, as indicated by reference number 448, at a third PEC count and/or a third temperature, another zone of word lines (e.g., a zone that includes four word lines) may be associated with the double-fine word line scheme.

In some implementations, a multi-fine program scheme may be applied to more than one zone based on a PEC count associated with the memory and/or a temperature associated with the memory. For example, as indicated by reference number 450, in some implementations a multi-fine program scheme (e.g., a double-fine program scheme) may be applied to two or more zones associated with the memory. Moreover, various amounts of fine pulses may be implemented based on different reliability risks (e.g., different RWB margins) of word lines within the zone. For example, as indicated by reference number 452, a triple-fine program scheme may be used for some word lines within a zone, and a double-fine program scheme may be used for other word lines within the zone. Additionally, or alternatively, an upper deck of memory (e.g., Deck 2) and a lower deck of memory (e.g., Deck 1) may be associated with a different combination of multi-fine program schemes. For example, as indicated by reference number 454, a zone in the upper deck may be associated with a triple-fine program scheme and a double-fine program scheme, while a zone in the lower deck may be associated with another multi-fine program scheme (e.g., a quad-fine program scheme, or the like) and/or a different combination of multi-fine program schemes (e.g., all double-fine program schemes, all triple-fine program schemes, one double-fine and two triple-fine program schemes, or the like).

Moreover, in some implementations, a multi-fine program scheme used by a memory device to program reliability risk word lines may be associated with a subblock-first program scheme, such as the subblock-first program scheme described above in connection with reference number 416 of FIG. 4B. However, in some other implementations, a multi-fine program scheme used by a memory device to program reliability risk word lines may be associated with a word-line-first program scheme. For example, FIG. 4G shows a sequence of operations, indicated by reference number 456, that may be used to perform a word-line-first program scheme (e.g., a word-line-first, double-fine program scheme). In the word-line first program scheme, for a first word line to be programmed (e.g., WL 1), the memory device may perform a coarse pulse on each subblock to be programmed, such as a coarse pulse on subblock 0 (shown as “1C”), a coarse pulse on subblock 1 (shown as “2C”), and so forth through subblock 3 (shown as “4C”). The memory device may then perform a coarse pulse on a first subblock (e.g., subblock 0) of the next WL to be programmed (e.g., WL 2), as shown as “5C.” Rather than proceeding with programming a fine pulse on a first subblock of the first WL (e.g., WL 1), as is the case for a subblock-first program scheme, the memory may, in this implementation, continue with coarse pulses on the word line being programmed (e.g., WL 2) until all coarse pulses have been completed for the given word line. More particularly, after programming the first subblock (e.g., subblock 0) on the second word line (e.g., WL 2), the memory device may perform a coarse pulse on each subblock of the word line to be programmed, such as a coarse pulse on subblock 1 (shown as “6C”), a coarse pulse on subblock 2 (shown as “7C”), and a coarse pulse on subblock 3 (shown as “8C”).

The memory device may then proceed with performing a fine pulse on a word line, and, more particularly, on each subblock of the word line. More particularly, the memory device may proceed with programming a fine pulse on subblock 0 of the first word line (shown as “9F”), a fine pulse on subblock 1 of the first word line (shown as “10F”), and so forth through subblock 3 (shown as “12F”). Similarly, the memory device may then proceed with performing a double fine pulse on a word line, and, more particularly, on each subblock of the word line. More particularly, the memory device may proceed with programming a double fine pulse on subblock 0 of the first word line (shown as “13FF”), a double fine pulse on subblock 1 of the first word line (shown as “14FF”), and so forth through subblock 3 (shown as “16FF”).

More generally, for the second and subsequent word lines, for a given word line M, the first subblock (e.g., subblock 0) may be associated with an N-th coarse pulse, an (N+16)-th fine pulse, and an (N+20)-th double fine pulse; the second subblock (e.g., subblock 1) may be associated with an (N+1)-th coarse pulse, an (N+17)-th fine pulse, and an (N+21)-th double fine pulse; the third subblock (e.g., subblock 2) may be associated with an (N+2)-th coarse pulse, an (N+18)-th fine pulse, and an (N+22)-th double fine pulse; and the fourth subblock (e.g., subblock 3) may be associated with an (N+3)-th coarse pulse, an (N+19)-th fine pulse, and an (N+23)-th double fine pulse. In this way, the memory device may be configured to complete a certain type of pulse (e.g., a coarse pulse, a fine pulse, a double fine pulse, or the like) for a given word line before moving onto another word line and/or type of pulse.

As indicated above, FIGS. 4A-4G are provided as examples. Other examples may differ from what is described with regard to FIGS. 4A-4G.

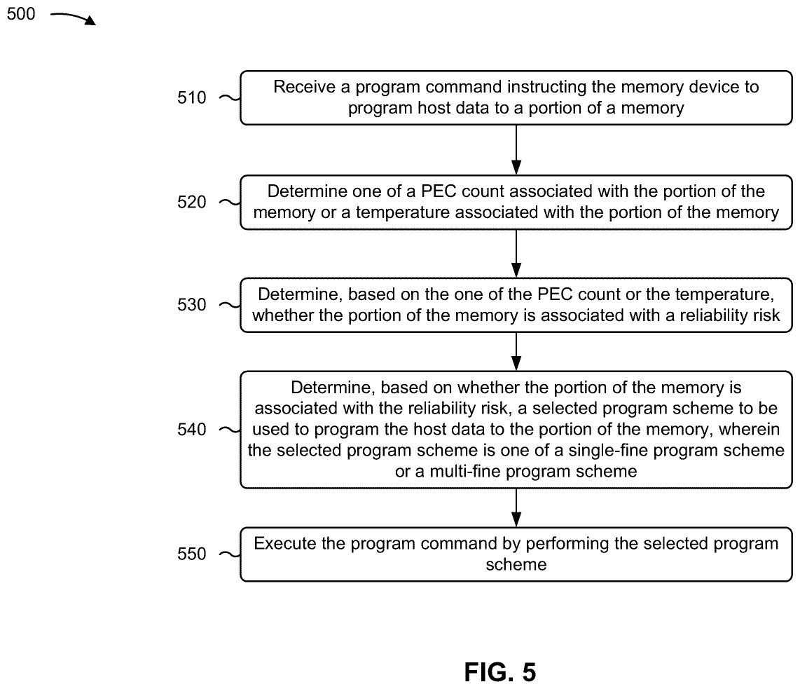

FIG. 5 is a flowchart of an example method 500 associated with selective use of a multi-fine program scheme for reliability risk word lines. In some implementations, a memory device (e.g., the memory device 120) may perform or may be configured to perform the method 500. In some implementations, another device or a group of devices separate from or including the memory device (e.g., the system 100) may perform or may be configured to perform the method 500. Additionally, or alternatively, one or more components of the memory device (e.g., the controller 130, the memory management component 225, the PEC count component 230, the temperature component 235, and/or the program component 240) may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 500.

As shown in FIG. 5, the method 500 may include receiving, from a host device, a program command instructing the memory device to program host data to a portion of a memory (block 510). As further shown in FIG. 5, the method 500 may include determining one of a PEC count associated with the portion of the memory or a temperature associated with the portion of the memory (block 520). As further shown in FIG. 5, the method 500 may include determining, based on the one of the PEC count or the temperature, whether the portion of the memory is associated with a reliability risk (block 530). As further shown in FIG. 5, the method 500 may include determining, based on whether the portion of the memory is associated with the reliability risk, a selected program scheme to be used to program the host data to the portion of the memory, wherein the selected program scheme is one of a single-fine program scheme or a multi-fine program scheme (block 540). As further shown in FIG. 5, the method 500 may include executing the program command by performing the selected program scheme (block 550).

The method 500 may include additional aspects, such as any single aspect or any combination of aspects described below and/or described in connection with one or more other methods or operations described elsewhere herein.

In a first aspect, the method 500 includes selecting the single-fine program scheme when the portion of the memory is not associated with the reliability risk, and selecting the multi-fine program scheme when the portion of the memory is associated with the reliability risk.

In a second aspect, alone or in combination with the first aspect, the portion of the memory is associated with a word line, the word line is associated with a word line group, and the one or more components, to determine whether the portion of the memory is associated with the reliability risk, are configured to determine whether the word line group is associated with the reliability risk.

In a third aspect, alone or in combination with one or more of the first and second aspects, determining whether the portion of the memory is associated with the reliability risk includes determining whether the portion of the memory is associated with the reliability risk using a lookup table.

In a fourth aspect, alone or in combination with one or more of the first through third aspects, determining whether the portion of the memory is associated with the reliability risk includes determining if the portion of the memory is associated with a first reliability risk category, a second reliability risk category, or a third reliability risk category, and determining the selected program scheme to be used to program the host data to the portion of the memory includes selecting the single-fine program scheme when the portion of the memory is associated with the first reliability risk category, selecting a first type of multi-fine program scheme when the portion of the memory is associated with the second reliability risk category, and selecting a second type of multi-fine program scheme, that is different from the first type of multi-fine program scheme, when the portion of the memory is associated with the third reliability risk category.

In a fifth aspect, alone or in combination with one or more of the first through fourth aspects, the multi-fine program scheme is associated with a word-line-first program scheme.

In a sixth aspect, alone or in combination with one or more of the first through fifth aspects, the multi-fine program scheme is associated with a subblock-first program scheme.

In a seventh aspect, alone or in combination with one or more of the first through sixth aspects, the memory is associated with one of a triple-level cell memory, a quad-level cell memory, or a penta-level cell memory.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

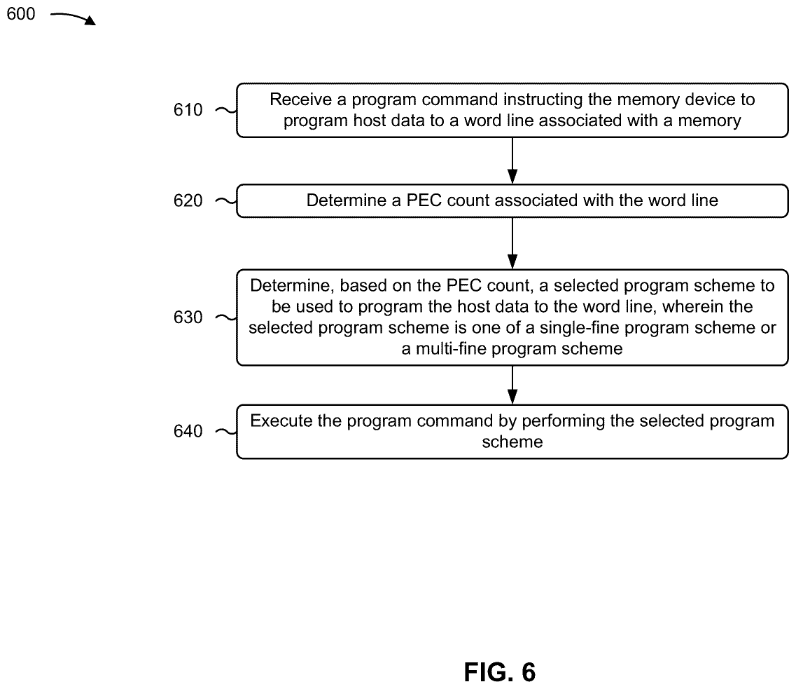

FIG. 6 is a flowchart of another example method 600 associated with selective use of a multi-fine program scheme for reliability risk word lines. In some implementations, a memory device (e.g., the memory device 120) may perform or may be configured to perform the method 600. In some implementations, another device or a group of devices separate from or including the memory device (e.g., the system 100) may perform or may be configured to perform the method 600. Additionally, or alternatively, one or more components of the memory device (e.g., the controller 130, the memory management component 225, the PEC count component 230, the temperature component 235, and/or the program component 240) may perform or may be configured to perform the method 600. Thus, means for performing the method 600 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 600.

As shown in FIG. 6, the method 600 may include receiving a program command instructing the memory device to program host data to a word line associated with a memory (block 610). As further shown in FIG. 6, the method 600 may include determining a PEC count associated with the word line (block 620). As further shown in FIG. 6, the method 600 may include determining, based on the PEC count, a selected program scheme to be used to program the host data to the word line, wherein the selected program scheme is one of a single-fine program scheme or a multi-fine program scheme (block 630). As further shown in FIG. 6, the method 600 may include executing the program command by performing the selected program scheme (block 640).

The method 600 may include additional aspects, such as any single aspect or any combination of aspects described below and/or described in connection with one or more other methods or operations described elsewhere herein.

In a first aspect, determining the selected program scheme to be used to program the host data to the word line includes determining the selected program scheme using a lookup table.

In a second aspect, alone or in combination with the first aspect, the lookup table indicates multiple PEC count thresholds and, for each PEC count threshold, of the multiple PEC count thresholds, a corresponding program scheme associated with each word line group, of multiple word line groups.

In a third aspect, alone or in combination with one or more of the first and second aspects, a first word line group, of the multiple word line groups, is associated with a first set of one or more word lines at a first PEC count threshold, of the multiple PEC count thresholds, and the first word line group is associated with a second set of one or more word lines, that is different from the first set of one or more word lines, at a second PEC count threshold, of the multiple PEC count thresholds.

In a fourth aspect, alone or in combination with one or more of the first through third aspects, determining the selected program scheme to be used to program the host data to the word line includes determining that the single-fine program scheme is to be used to program the host data to the word line when the PEC count is associated with a first PEC threshold, determining that a double-fine program scheme is to be used to program the host data to the word line when the PEC count is associated with a second PEC threshold, and determining that a triple-fine program scheme is to be used to program the host data to the word line when the PEC count is associated with a third PEC threshold.

In a fifth aspect, alone or in combination with one or more of the first through fourth aspects, the multi-fine program scheme is associated with a word-line-first program scheme.

In a sixth aspect, alone or in combination with one or more of the first through fifth aspects, the multi-fine program scheme is associated with a subblock-first program scheme.

In a seventh aspect, alone or in combination with one or more of the first through sixth aspects, the memory is associated with one of a triple-level cell memory, a quad-level cell memory, or a penta-level cell memory.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

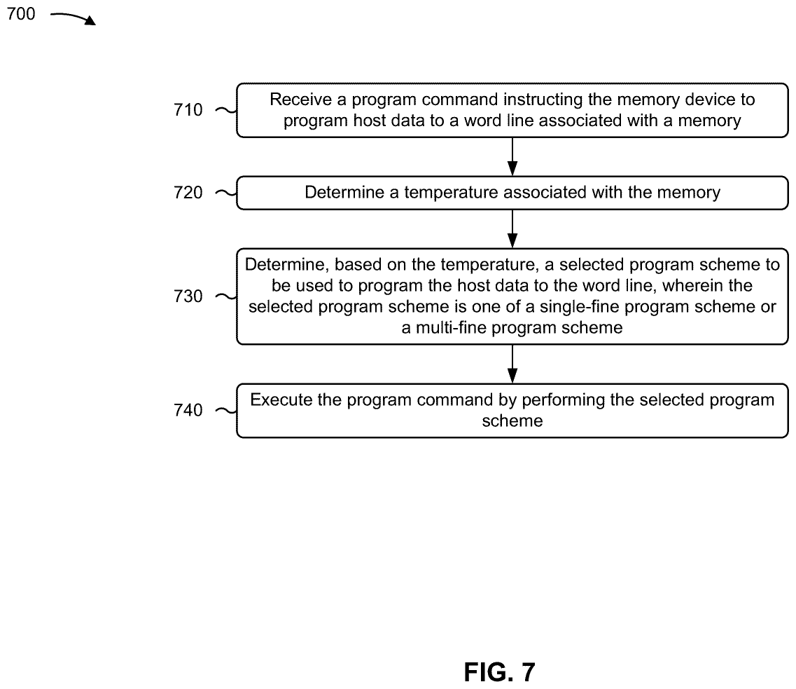

FIG. 7 is a flowchart of another example method 700 associated with selective use of a multi-fine program scheme for reliability risk word lines. In some implementations, a memory device (e.g., the memory device 120) may perform or may be configured to perform the method 700. In some implementations, another device or a group of devices separate from or including the memory device (e.g., the system 100) may perform or may be configured to perform the method 700. Additionally, or alternatively, one or more components of the memory device (e.g., the controller 130, the memory management component 225, the PEC count component 230, the temperature component 235, and/or the program component 240) may perform or may be configured to perform the method 700. Thus, means for performing the method 700 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 700.

As shown in FIG. 7, the method 700 may include receiving a program command instructing the memory device to program host data to a word line associated with a memory (block 710). As further shown in FIG. 7, the method 700 may include determining a temperature associated with the memory (block 720). As further shown in FIG. 7, the method 700 may include determining, based on the temperature, a selected program scheme to be used to program the host data to the word line, wherein the selected program scheme is one of a single-fine program scheme or a multi-fine program scheme (block 730). As further shown in FIG. 7, the method 700 may include executing the program command by performing the selected program scheme (block 740).

The method 700 may include additional aspects, such as any single aspect or any combination of aspects described below and/or described in connection with one or more other methods or operations described elsewhere herein.

In a first aspect, determining the selected program scheme to be used to program the host data to the word line includes determining the selected program scheme using a lookup table.

In a second aspect, alone or in combination with the first aspect, the lookup table indicates multiple temperature ranges and, for each temperature range, of the multiple temperature ranges, a corresponding program scheme and a corresponding set of word lines associated with the corresponding program scheme.

In a third aspect, alone or in combination with one or more of the first and second aspects, determining the selected program scheme to be used to program the host data to the word line includes determining that the single-fine program scheme is to be used to program the host data to the word line when the temperature is associated with a first temperature range, determining that a double-fine program scheme is to be used to program the host data to the word line when the temperature is associated with a second temperature range, and determining that a triple-fine program scheme is to be used to program the host data to the word line when the temperature is associated with a third temperature range.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory device includes one or more components configured to: receive, from a host device, a program command instructing the memory device to program host data to a portion of a memory; determine one of a EC) count associated with the portion of the memory or a temperature associated with the portion of the memory; determine, based on the one of the PEC count or the temperature, whether the portion of the memory is associated with a reliability risk; determine, based on whether the portion of the memory is associated with the reliability risk, a selected program scheme to be used to program the host data to the portion of the memory, wherein the selected program scheme is one of a single-fine program scheme or a multi-fine program scheme; and execute the program command by performing the selected program scheme.

In some implementations, a method includes receiving, by a memory device from a host device, a program command instructing the memory device to program host data to a word line associated with a memory; determining, by the memory device, a PEC count associated with the word line; determining, by the memory device and based on the PEC count, a selected program scheme to be used to program the host data to the word line, wherein the selected program scheme is one of a single-fine program scheme or a multi-fine program scheme; and executing, by the memory device, the program command by performing the selected program scheme.

In some implementations, a method includes receiving, by a memory device from a host device, a program command instructing the memory device to program host data to a word line associated with a memory; determining, by the memory device, a temperature associated with the memory; determining, by the memory device and based on the temperature, a selected program scheme to be used to program the host data to the word line, wherein the selected program scheme is one of a single-fine program scheme or a multi-fine program scheme; and executing, by the memory device, the program command by performing the selected program scheme.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host device, a program command instructing the memory device to program host data to a portion of a memory;
determine one of a program erase cycle (PEC) count associated with the portion of the memory or a temperature associated with the portion of the memory;
determine, based on the one of the PEC count or the temperature, whether the portion of the memory is associated with a reliability risk;
determine, based on whether the portion of the memory is associated with the reliability risk, a selected program scheme to be used to program the host data to the portion of the memory, wherein the selected program scheme is one of a single-fine program scheme or a multi-fine program scheme; and
execute the program command by performing the selected program scheme.

2. The memory device of claim 1, wherein the one or more components, to determine the selected program scheme to be used to program the host data to the portion of the memory, are configured to:
select the single-fine program scheme when the portion of the memory is not associated with the reliability risk; and
select the multi-fine program scheme when the portion of the memory is associated with the reliability risk.

3. The memory device of claim 1, wherein the portion of the memory is associated with a word line,
wherein the word line is associated with a word line group, and
wherein the one or more components, to determine whether the portion of the memory is associated with the reliability risk, are configured to determine whether the word line group is associated with the reliability risk.

4. The memory device of claim 1, wherein the one or more components, to determine whether the portion of the memory is associated with the reliability risk, are configured to determine whether the portion of the memory is associated with the reliability risk using a lookup table.

5. The memory device of claim 1, wherein the one or more components, to determine whether the portion of the memory is associated with the reliability risk, are configured to determine if the portion of the memory is associated with a first reliability risk category, a second reliability risk category, or a third reliability risk category, and
wherein one or more components, to determine the selected program scheme to be used to program the host data to the portion of the memory, are configured to:
select the single-fine program scheme when the portion of the memory is associated with the first reliability risk category;
select a first type of multi-fine program scheme when the portion of the memory is associated with the second reliability risk category; and
select a second type of multi-fine program scheme, that is different from the first type of multi-fine program scheme, when the portion of the memory is associated with the third reliability risk category.

6. The memory device of claim 1, wherein the multi-fine program scheme is associated with a word-line-first program scheme.

7. The memory device of claim 1, wherein the multi-fine program scheme is associated with a subblock-first program scheme.

8. The memory device of claim 1, wherein the memory is associated with one of a triple-level cell memory, a quad-level cell memory, or a penta-level cell memory.

9. A method, comprising:
receiving, by a memory device from a host device, a program command instructing the memory device to program host data to a word line associated with a memory;
determining, by the memory device, a program erase cycle (PEC) count associated with the word line;
determining, by the memory device and based on the PEC count, a selected program scheme to be used to program the host data to the word line, wherein the selected program scheme is one of a single-fine program scheme or a multi-fine program scheme; and
executing, by the memory device, the program command by performing the selected program scheme.

10. The method of claim 9, wherein determining the selected program scheme to be used to program the host data to the word line includes determining the selected program scheme using a lookup table.

11. The method of claim 10, wherein the lookup table indicates multiple PEC count thresholds and, for each PEC count threshold, of the multiple PEC count thresholds, a corresponding program scheme associated with each word line group, of multiple word line groups.

12. The method of claim 11, wherein a first word line group, of the multiple word line groups, is associated with a first set of one or more word lines at a first PEC count threshold, of the multiple PEC count thresholds, and
wherein the first word line group is associated with a second set of one or more word lines, that is different from the first set of one or more word lines, at a second PEC count threshold, of the multiple PEC count thresholds.

13. The method of claim 9, wherein determining the selected program scheme to be used to program the host data to the word line includes:
determining that the single-fine program scheme is to be used to program the host data to the word line when the PEC count is associated with a first PEC threshold;
determining that a double-fine program scheme is to be used to program the host data to the word line when the PEC count is associated with a second PEC threshold; and
determining that a triple-fine program scheme is to be used to program the host data to the word line when the PEC count is associated with a third PEC threshold.

14. The method of claim 9, wherein the multi-fine program scheme is associated with a word-line-first program scheme.

15. The method of claim 9, wherein the multi-fine program scheme is associated with a subblock-first program scheme.

16. The method of claim 9, wherein the memory is associated with one of a triple-level cell memory, a quad-level cell memory, or a penta-level cell memory.

17. A method, comprising:
receiving, by a memory device from a host device, a program command instructing the memory device to program host data to a word line associated with a memory;
determining, by the memory device, a temperature associated with the memory;
determining, by the memory device and based on the temperature, a selected program scheme to be used to program the host data to the word line, wherein the selected program scheme is one of a single-fine program scheme or a multi-fine program scheme; and
executing, by the memory device, the program command by performing the selected program scheme.

18. The method of claim 17, wherein determining the selected program scheme to be used to program the host data to the word line includes determining the selected program scheme using a lookup table.

19. The method of claim 18, wherein the lookup table indicates multiple temperature ranges and, for each temperature range, of the multiple temperature ranges, a corresponding program scheme and a corresponding set of word lines associated with the corresponding program scheme.

20. The method of claim 17, wherein determining the selected program scheme to be used to program the host data to the word line includes:
determining that the single-fine program scheme is to be used to program the host data to the word line when the temperature is associated with a first temperature range;
determining that a double-fine program scheme is to be used to program the host data to the word line when the temperature is associated with a second temperature range; and
determining that a triple-fine program scheme is to be used to program the host data to the word line when the temperature is associated with a third temperature range.
